(19) United States
(12) Patent Application Publication
(10) Pub. No.: US 2019/0118126 A1
(43) Pub. Date: Apr. 25, 2019

(54) FILTER BAG ASSEMBLY COMPRISING CATALYTIC MATERIAL

(71) Applicant: Haldor Topsøe A/S, Kgs. Lyngby (DK)

(72) Inventors: Thomas Holten Kollin, Brønshøj (DK); Kim Hougaard Pedersen, Virum (DK); Viggo Lucassen Hansen, Brønshøj (DK)

(73) Assignee: Haldor Topsøe A/S, Kgs. Lyngby (DK)

(21) Appl. No.: 16/094,541

(22) PCT Filed: Jul. 3, 2017
(86) PCT No.: PCT/EP2017/066477

§ 371 Date: Oct. 18, 2018

(30) Foreign Application Priority Data
Jul. 4, 2016 (DK) PA 2016 00398

(51) Int. Cl. B01D 46/00; B01D 46/02; B01D 53/86

(52) U.S. Cl. CPC B01D 46/0024; B01D 46/02; B01D 53/86; B01D 2255/904; B01D 2255/2065; B01D 2255/20707; B01D 2257/708; B01D 2255/2073; B01D 2255/20723; B01D 2255/20738; B01D 2255/20776; B01D 2257/404; B01D 2255/1023

(57) ABSTRACT

Filter bag assembly for use in cleaning of process gas comprising an outer filter bag and one or more inner filter bags separately arranged within the outer filter bag, and said one or more inner filter bags also separately arranged within each other, the one or more inner filter bags and the outer filter bags are provided with catalytically active material.

The present invention relates to a filter bag assembly comprising multiple fabric filter bags coaxially arranged within an outer filter bag. More particularly, the invention provides a filter assembly comprising an outer filter bag and within the outer filter bag, one or more inner filter bags are separately installed within the outer filter bag and within each other for the removal of dust and particulate matter in a process gas. At least one of the filter bags is catalyzed filter bag for the removal of harmful components contained in the process gas. The filter bag assembly is in particular useful in the cleaning of process or raw gas from industrial processes involving combustion, like the production of minerals, cement, waste incineration, or from coal fired boilers.

Fabric filters in form of filter bags are extensively used in many industries for removal of particulate matter from process gases. They are one of the most efficient types of dust collectors available and can achieve collection efficiencies of more than 99% for particulates. The bags can be made from various woven or felted materials or mixtures thereof comprising natural fibres, synthetic fibres, or other fibres such as glass, ceramic or metallic fibres.

The high particulate removal efficiency of fabric filters is partly due to the dust cake formed on the surfaces of the filter bags and partly due to the filter bag composition and production quality as well as the quality of the fabric filter construction itself. The fabric provides a surface on which dust particulates collect. Due to the composition of the fibers constituting the filter bags, these are normally operated at temperatures lower than 250° C.

The particle-containing process gas very often contains a plurality of pollutants, e.g. NOₓ, volatile organic compounds (VOC), SO₂, CO, Hg, NH₃, dioxins and furans, in concentrations that have to be reduced depending on local legislation. For this purpose, several conventional methods are available. In all cases additional units up/downstream the fabric filter bags have to be installed and operated.

The abatement of gaseous contaminants like NOₓ, VOC, dioxins and furans can be effectively carried out by contact with a catalyst. In particular, vanadium oxide-based SCR catalysts are commonly used catalysts for NOₓ reduction by selective reduction of NOₓ with NH₃ in stationary and automotive applications.

The general object of the present invention is to combine mechanical removal of dust and particulate matter and catalytic removal of gaseous contaminants, which are contained in industrial process gasses by means of a fabric filter bag assembly product.

To be effective in the abatement of carbon monoxide and selected VOCs (e.g. propane, ethylene) a catalytic system needs to include a platinum group metal. By reasons at further discussed in the following description, palladium is the preferred platinum group metal.

The SCR catalyst is only functional if a reductant is present in the gas to be cleaned. The most common reductant is ammonia introduced into gas either as such or urea or ammonium chloride as its precursor.

The problem arises when the ammonia concentration over the palladium catalyst is higher than a certain limit, the palladium catalyst is deactivated by NH3. Therefore an SCR catalyst arranged upstream the palladium catalyst must remove ammonia by the known SCR reaction with NOx to a concentration of less than 10 ppm by volume to prevent deactivation of palladium catalyst.

However, this is only possible for vanadium oxide-based SCR catalysts in a temperature range where the SCR catalyst is active that is a temperature T>190° C.

This is a problem during shut down and periods with lower temperature in a filter house with the catalyzed fabric filter bags.

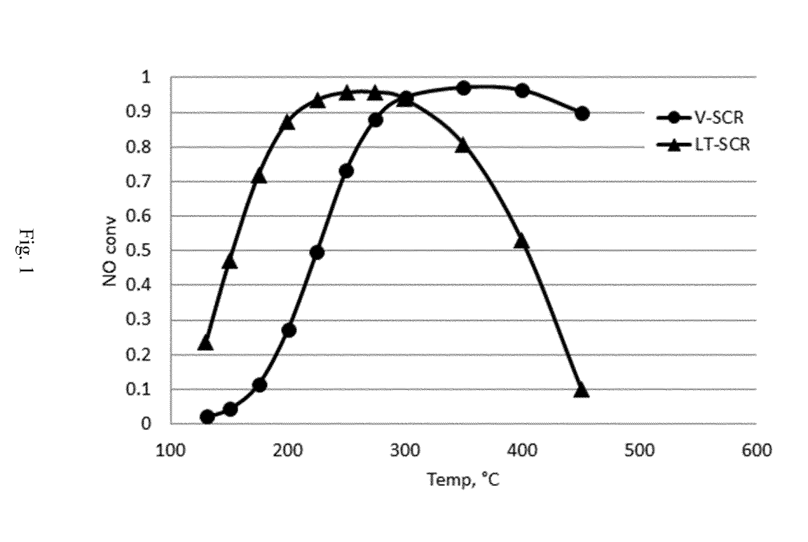

The above problem can be effectively solved by arranging a low temperature SCR catalyst comprising at least one of the oxides of manganese, cerium and iron supported on titania. Such an SCR catalyst has still sufficient catalytic activity at temperatures well below 190° C., e.g. 130° C., as shown in FIG. 1 of the drawings. Thereby, it is possible to remove or sufficiently reduce ammonia slip from the SCR catalyst at lower temperatures and to protect the downstream palladium from deactivation. Additionally, when employing a combination of the low temperature and high temperature vanadium oxide-based SCR catalyst increases advantageously the overall temperature range of the SCR process.

Thus, this invention provides a filter bag assembly for use in cleaning of process gas comprising an outer filter bag and least a first and second inner filter bag, the first inner bag arranged within the outer filter bag, and the second inner bag arranged within the first inner bag, the at least first and second inner filter bags and the outer filter bag having an open end and a closed end, wherein the first inner bag is catalyzed with a first SCR catalyst composition comprising at least one of oxides of manganese, iron and cerium supported on titania and wherein the second inner bag is catalyzed with a second catalyst composition comprising palladium in metallic and/or oxidic form.

As mentioned hereinbefore, when combining the first low temperature catalyst (LT-SCR) with a high temperature SCR vanadium oxide-based SCR catalyst (V-SCR) comprised in the first catalyst applied on the first inner bag, the temperature range of the SCR process in the filter bag assembly is much increased, as shown in FIG. 1.

Consequently, in a preferred embodiment of the invention, the first SCR catalyst composition further comprises a vanadium oxide and titania.

A further advantage of this embodiment is a decreased or no formation of laughter gas (N₂O), when reacting nitrogen oxides with ammonia in presence of the low temperature first catalyst composition comprising at least one of the oxides of manganese, iron and cerium supported on titania and further comprising a vanadium oxide and titania.

Alternatively or in combination with the above preferred embodiment, it can be preferred that the second catalyst composition comprising palladium in metallic and/or oxidic form further comprises a vanadium oxide and titania.

This catalyst composition is preferred for the following reasons. The Pd/V/Ti catalyst has i) dual functionality (removal of NOx and removal of VOC, volatile organic compounds); ii) a S-tolerance; and iii) a lower SO₂ oxidation activity compared to other catalyst compositions, e.g. Pt-based catalysts.

Additionally, when employing a Pd/V/Ti catalyst the catalyzed filter bags are sulfur resistant, i.e. not subjected to sulfur deactivation. The Pd/V/Ti catalyst additionally reduces the amount of SO₃ formed by oxidation of SO₂. If H₂S is also present in the process gas entering the filter bag assembly, it will be oxidized to SO₂ on both the V/Ti and Pd/V/Ti catalyst.

In further an embodiment of the invention alone or combination with the above embodiments, the outer filter bag is catalysed with a third catalyst composition free of palladium and comprising a vanadium oxide and titania.

In a further embodiment of the invention, the first catalyst composition comprises a mixture of the oxides of manganese, iron and cerium supported on titania.

At least one of the first, second and third catalyst composition can further comprise oxides of tungsten and/or molybdenum.

The advantage of this embodiment lies in the stabilizing effect of tungsten oxide and/or molybdenum oxide and additionally in an improved SCR activity.

The term “outer bag” as used herein before and in the following description and in the appended claims, refers to the filter bag through which the process gas passes first and the term “inner bag” refers to the filter bag(s) through which the process gas passes subsequently after having passed through the outer bag.

The term “a vanadium oxide” or “vanadium oxide” refers to:

Vanadium(II)oxide (vanadium monoxide), VO; or

vanadium (III) oxide (vanadium sesquioxide or trioxide), V₂O₃; or

vanadium (IV)oxide (vanadium dioxide), VO₂; or

vanadium (V)oxide (vanadium pentoxide), V₂O₅.

Preferably, vanadium oxide for use in the invention comprises or consists of vanadium (V)oxide (vanadium pentoxide), V₂O₅.

The term “titania” refers to titanium dioxide (TiO₂).

The outer and subsequent series of inner filter bags are made from porous filter media of material suitable for different process conditions. The bag material is sewn or welded into the filter bag.

Preferably, the outer filter bag and the one or more inner filter bags are made of woven fabric or needle felt of individual organic or inorganic fibers.

The catalytically active material is supported on the woven fabric or needle felt.

The most common filter bag material used in e.g. cement kiln applications is glass fibre material, optionally with a thin polymer membrane on the outside of the outer bag that faces the process gas.

The polymeric membrane is preferably made of polytetrafluoroethylene.

The membrane protects the catalyst from contamination by catalyst poisons contained in particular matter.

1. A filter bag assembly for use in cleaning of process gas comprising an outer filter bag and least a first and second inner filter bag, the first inner bag arranged within the outer filter bag, and the second inner bag arranged within the first inner bag, the at least first and second inner filter bags and the outer filter bags having an open end and a closed end, wherein the first inner bag is catalyzed with a first SCR catalyst composition comprising at least one of oxides of manganese, iron and cerium supported on titania and wherein the second inner bag is catalyzed with a second catalyst composition comprising palladium in metallic and/or oxidic form.

2. The filter bag assembly of claim 1, wherein the first SCR catalyst composition further comprises a vanadium oxide and titania.

3. The filter bag assembly of claim 1, wherein the second catalyst composition further comprises a vanadium oxide and titania.

4. The filter bag assembly of claim 1, wherein the outer filter bag is catalysed with a third catalyst composition free of palladium and comprising a vanadium oxide and titania.

5. The filter bag assembly of claim 2, wherein the vanadium oxide comprises vanadium(V)oxide.

6. The filter bag assembly of claim 1,
wherein the outer filter bag and at least first and second filter bag are made of woven fabric or needle felt of individual organic or inorganic fibers.

7. The filter bag assembly of claim 6, wherein the organic or inorganic fibers comprise glass fibre material.

8. The filter bag assembly of claim 1,
wherein the outer tube is provided with a polymeric membrane on the outside of the outer bag that faces the process gas.

9. The filter bag assembly of claim 8, wherein the polymeric membrane consists of polytetrafluoroethylene.

10. The filter bag assembly of claim 1, wherein the first, and/or the second catalyst and/or the third catalyst composition further comprises at least one of an oxide of tungsten and an oxide of molybdenum.

11. The filter bag assembly of claim 1,
wherein the first catalyst composition comprises a mixture of the oxides of manganese, iron and cerium supported on titania.
